(19) United States
(12) Patent Application Publication
(10) Pub. No.: US 2006/0032484 A1
(43) Pub. Date: Feb. 16, 2006

(54) Electro-charger

(76) Inventor: Sean Gregory Hutchinson, Gaston, NC (US)

Correspondence Address: Sean Gregory Hutchinson, P.O. Box 993, Gaston, NC, 27832, US

(21) Appl. No.: 10/657,031

(22) Filed: Aug. 11, 2004

(51) Int. Cl. F02B 33/00

(52) U.S. Cl. 123/565

(57) ABSTRACT

The electro-charger revolutionizes the after market automotive industry because it can be applied to any gasoline engine with considerably less complications than a turbo or super-charger. The electro-charger is easier to control than turbo and super-chargers therefore it is safer to use. Since the electro-charger does not require any power from the engine in the form of exhaust gases or beltdrive systems, it increases the power output of an engine greater than that of a turbo or super-charger with equal pounds of boost.

### BACKGROUND OF THE ELECTRO-CHARGER

The electro-charger pertains to the automotive industry. It is a device to be implemented on gasoline powered mobiles whether they're motorcycles, cars or trucks for an increase in engine performance. “Performance” in the last statement can be interpreted as “horsepower”.

Today in the automotive field, there are numerous ways to increase performance or engine power, turbo and super-chargers are two of the most common. A turbo is basically a centrifugal compressor which is actuated by exhaust gasses which turn a turbine at high speeds. the turbine is connected by a shaft to the compressor blades, which as they turn, they force more air into the intake of a vehicle, and with added fuel the engine power output is increased greatly. A Supercharger is basically a compressor (not necessarily a centrifugal one), that is actuated by the existing belt-drive on an automobile's engine. The compressor blades are connected to some type of pulley which is spun at high speeds by a series of gearing. For example, every rotation the engine makes the charger may rotate 5 to 10 times that number (gear reduction).

While these methods are good ways to add power, they take power from the engine to operate them. A typical super-charger can take up to 23% of the engine's power to spin at full “boost”. Boost is in simplest terms, air pressure. A turbo, because it is integrated in the exhaust stream of an engine, takes typically 11% to 14% of total engine power to run which is less than a supercharger, but still is a significant amount of power taken from the engine.

### BRIEF SUMMARY OF THE ELECTRO-CHARGER

This is where the electro-charger differs from turbo and super-chargers. The electro-charger is basically a centrifugal compressor driven solely by it's own electric motor. The motor is powered by a power inverter, which converts D/C to A/C, and steps the A/C voltage up to 120 volts at approximately 12 amps*. This voltage is then sent through a selector switch which controls the voltage reaching the motor of the electro-charger, in turn controlling the speed at which it rotates, this is a type of “boost control”. Fuel enrichment is handled the same typical way as with a turbo or super-charger's FMU**. The electro-charger is a unit that can be mounted on almost any vehicle with the right fuel upgrades and is easier/cheaper to install than a turbo or super-charger. The electro-charger takes none of the engines horsepower because it is driven by voltage not belts or exhaust gasses. The electro-charger is switch activated therefore, it operates only at the driver's discretion so an engine still get great gas mileage when performance is not needed, unlike a turbo or super-charger. In a boost for boost comparison the electro-charger produces more power, is easier to control, and is more engine efficient than either a turbo or super-charger.
*The voltage (12VDC) is supplied by the vehicle's battery.

**FMU stands for Fuel Management Unit, which increases fuel pressure as boost rises.

### BRIEF DESCRIPTION OF THE SEVERAL VIEWS OF THE DRAWING

FIG. 1 depicts the electro-charger from a diagonal point of view where: “A” represents the wires from the automobile battery to the power inverter. “B” represents wire paths from the electric motor and the on-board adjuster/activation switch to the power inverter output terminals. “C” represents the on-board adjuster activation switch or throttle switch. “D” represents the electric motor with its cooling fan vents. “F” is the body of the centrifugal compressor. “G” represents air being pulled in at high speed through a high flow air filter. “H” represents compressed air leaving the compressor in route to the intake of the engine or to an optional inter-cooler (a device used to cool the compressed air). “I” is the power inverter box which supplies the current.

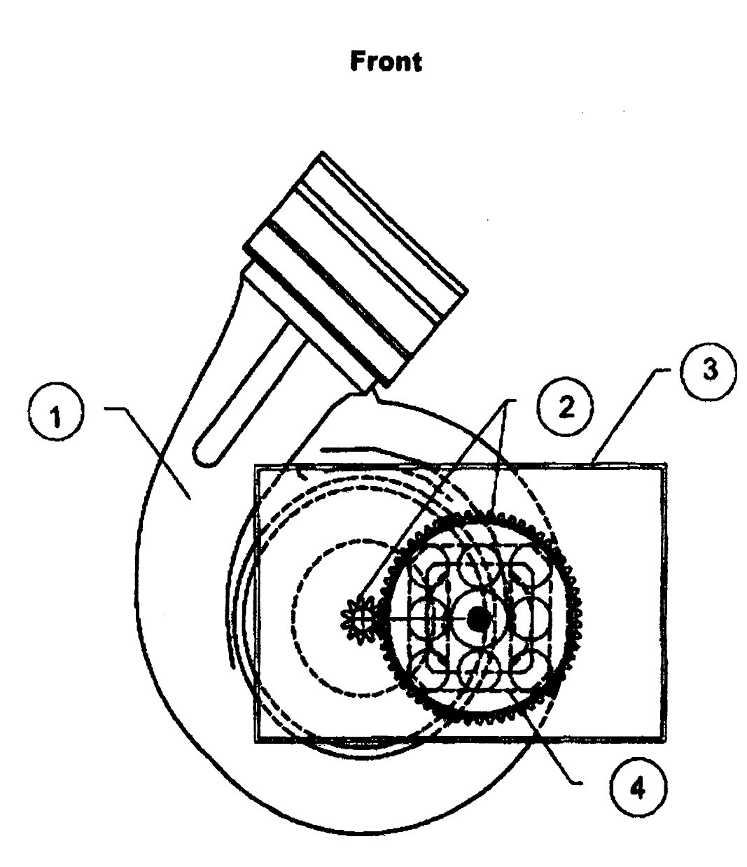

FIG. 2 is a top view of the electro-charger where: “A” is compressed air to the engine. “B” is the gear reduction system casing. “C” is the electric motor where “C” shows how the motor can be mounted on the opposing side to accommodate easier installation in some cases, by making the unit more compact. “D” is the on-board adjuster/activation switch or throttle switch. “E” represents the wiring from the electric motor and the switch to the power inverter output. “F” is the power inverter box. “G” represents the wires from the automobile battery to the power inverter.

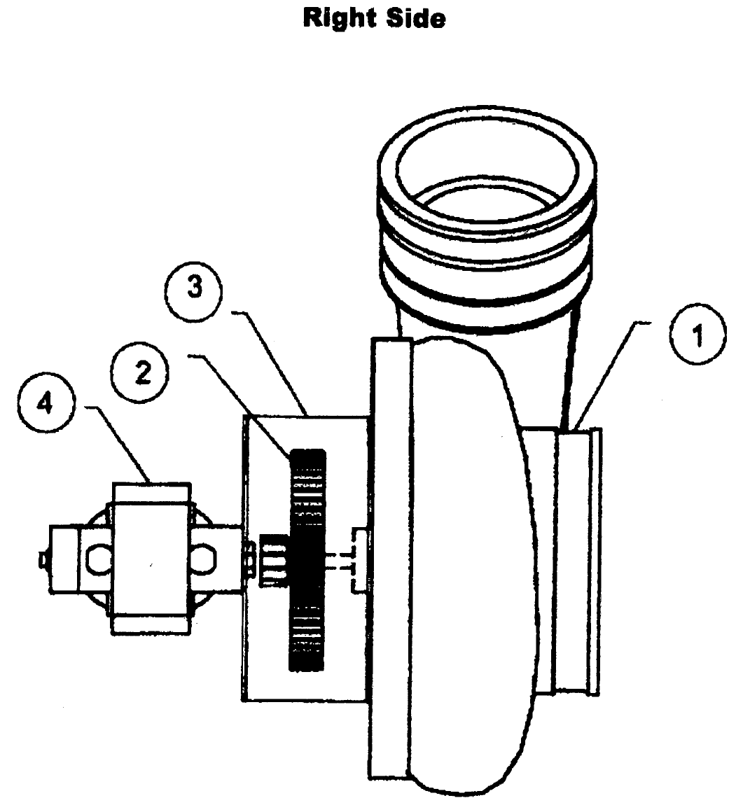

FIG. 3 is a cut-away view of the gear reduction system where: “A” represents the gear reduction system casing. “B” represents the electric motor with its internal cooling fan. “C” represents the primary gear which is directly mounted to the shaft of the electric motor. “D” Represents the compressor. “E” represents the secondary gear which spins at approximately 5 to 10 times faster than the primary gear because it is much smaller. “F” is the “drive chain” which transfers rotational energy between the primary and secondary gears.

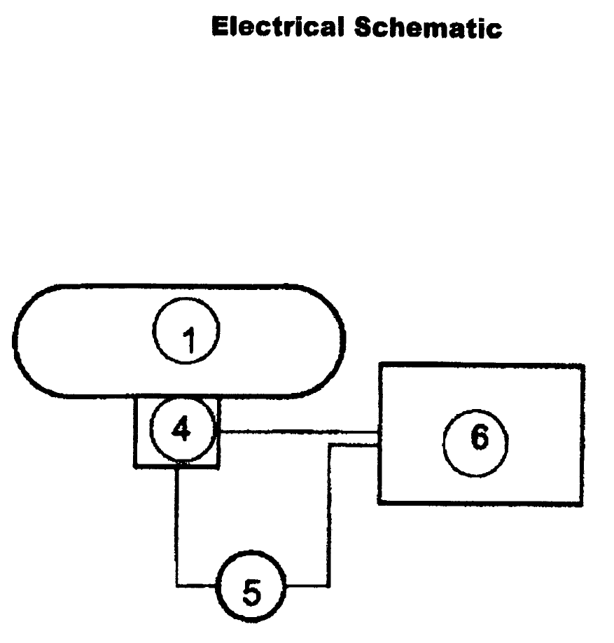

FIG. 4 is a cut-away view of the compressor side of the unit where: “A” represents wiring. “B” represents the electric motor. “C” is the gear reduction system casing. “D” is the hose to route the compressed air to the engine. “E” is the air in-let hose to the compressor. “F” represents incoming air to the compressor. “G” represents outgoing compressed air en-route to the engine. “H” represents the impeller which is directly connected to the secondary gear.

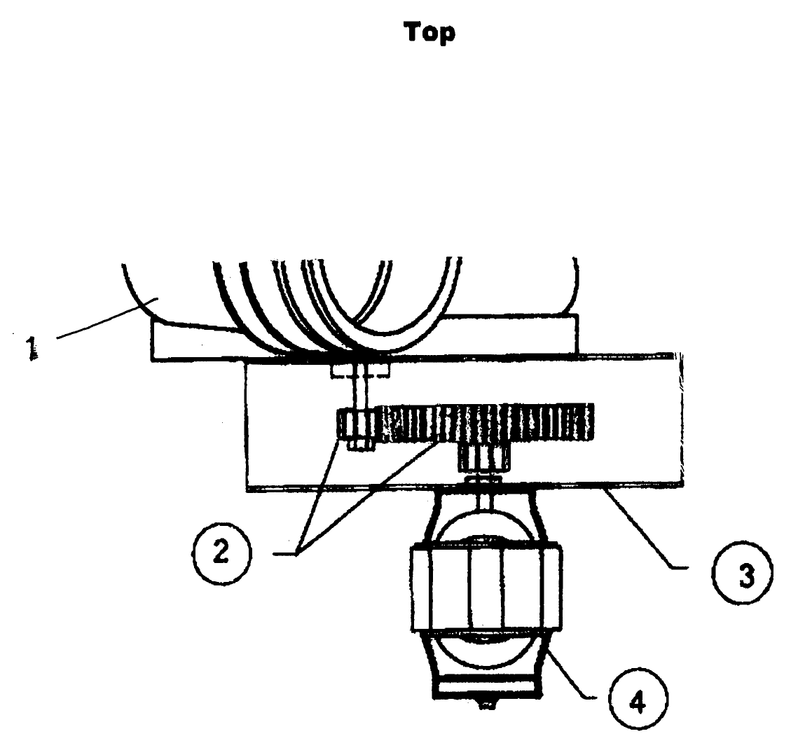

### DETAILED DESCRIPTION OF THE ELECTRO-CHARGER

The electro-charger is a device which increases the output of gasoline engines. It differs from the “old” means which are turbo and super-chargers because it is a self powered unit, meaning it does not rely on power derived from the engine itself to introduce its power effects onto the engine. It is adaptable for any gasoline engine and because it doesn't need a specific exhaust manifold like a turbo-charger, or a specific beltdrive like a super-charger, its installation capabilities are much less complicated. The electro-charger does not absorb power from the engine so the efficiency is better and more power per pound of boost is achieved.

An electro-charger is created when a centrifugal compressor is mated to an electronic motor. The impeller inside of the compressor which rotates, pulls air in and compresses it is directly connected to a shaft leading to a small gear, wheel, or pulley. The small gear, or pulley is chain or belt driven respectively, by a larger gear or pulley, five to six times larger. In some cases two interlocking gears can be used in place of the two wheels. The proportion in gear and wheel or pulley sizes creates a “step-up” ratio. The larger gear, wheel, or pulley is directly connected to an electric motor. The motor rotates the attached object at approximately 15,000 rpm. The ratio of the larger gear to the smaller gear is five to one, or six to one. This will cause the small wheel, gear or pulley to spin at approximately 90,000 rpm. At this speed there is a great increase in the amount of air pulled in and pushed out. In limited cases the impeller can be directly connected to the electric motor. This is called a “direct-drive” set up, which is limited on its rpm and boost because the electric motor's rotational speed is not enhanced by a step up gear, pulley, or wheel set up.

To operate the electric motor, a power inverter is used. This device uses the current from the automobile battery and inverts it to usable A/C current for the motor. The onboard adjuster/activation switch is used to determine what level of boost the operator wishes to utilize. The switch controls the voltage reaching the electric motor, thereby controlling its rotational speed. The higher the rotational speed, more boost is achieved. The lower the rotational speed, less boost is achieved. Some operators might prefer the use of a throttle switch where the current is “fixed” and only supplied when the throttle of the automobile is wide open.

As with a turbo or super-charger, compressed air to the intake of an engine gets hot, therefore, at higher boost levels an intercooler may be supplied to cool the incoming air to the engine. This device will increase engine output even more and makes it safer for the engine to operate with the higher boost.

as stated earlier, the electro-charger can be used on a wide range of vehicles. For average everyday vehicles, it will have a “mild” range of boost levels, approximately between the ranges of four to nine pounds per square inch. For racing applications however, the boost levels may range from ten pounds to thirty pounds or higher per square inch. racing engines are tweaked to handle that kind of boost and special high boost electro-chargers should only be employed on such engines. Too much boost on a regular engine will cause severe damage to parts of the engine.

The on-board switch is an added advantage because the operator can select what level of boost they desire or just turn off the unit if they want to conserve gas. Once a turbo or super-charger is installed they are always active and burns much more gas than a an engine with out one would. An electro-charged engine can still have the gas mileage of a normal engine at the operators demand. Also in the event of a malfunction of a turbo or super-charger, the engine attached to one becomes useless. In contrast if the electro-charger malfunctions it can be shutoff and the automobile can still move and operate safely.

This is a request for a non-provisional patent for the invention entitled the “Electro-Charger”, which is a device invented for the sole purpose of increasing the horsepower output of a gasoline engine. The electro-charger consists of a centrifugal air compressor which is either directly driven by an electric motor, or driven by an electric motor through a gear, pulley, or a wheel “step-up” system. The fact that it uses no engine power to operate, and is not plumbed into the exhaust system of an automobile engine, means the electro-charger will be more efficient and possess a greater level of versatility in comparison to other charging systems, namely turbo and super-chargers.

What I claim as my invention is:

1) The electro-charger which incorporates the use of an electric powered motor directly operating a centrifugal air compressor or indirectly operating it through gears, pulleys, or wheels, for the sole purpose of increasing the horsepower output of an internal combustion gasoline engine.

2) The invention encompasses the use of an electric motor regardless of size, rotational speed, and power rating with any centrifugal type air compressor regardless of size or output rating.
